(19) United States
(12) Patent Application Publication
(10) Pub. No.: US 2026/0324684 A1
(43) Pub. Date: Oct. 22, 2026

(54) SEAWEED FEED PRODUCTS AND METHODS FOR PROCESSING SEAWEED

(71) Applicant: CH4 Global, Inc., Henderson, NV (US)

(72) Inventors: Gary Robert Kelm, Henderson, NV (US); Stephen Trevor Meller, Henderson, NV (US); Paul Joseph Russo, Henderson, NV (US); David Lawson, Henderson, NV (US)

(73) Assignee: CH4 Global, Inc., Henderson, NV (US)

(21) Appl. No.: 19/115,644

(22) PCT Filed: Sep. 28, 2023
(86) PCT No.: PCT/US2023/075381

§ 371 Date: Mar. 26, 2025

Related U.S. Application Data
(60) Provisional application No. 63/411,342, filed on Sep. 29, 2022.
(60) Provisional application No. 63/486,615, filed on Feb. 23, 2023.

(51) Int. Cl. A23K 10/30; A23K 10/40; A23K 20/163; A23K 50/10

(52) U.S. Cl. CPC A23K 10/30; A23K 10/40; A23K 20/163; A23K 50/10

(57) ABSTRACT

Embodiments of the present disclosure include seaweed feed products that comprise halogenated compound-diminished seaweed material, a binding agent, and one or more bound halogenated compounds, wherein the one or more bound halogenated compounds are bound to at least a portion of the binding agent. Also disclosed herein are methods of feeding ruminants, feed products, methods for administering halogenated compounds to ruminants, methods for processing seaweed, and boluses and licks for ruminant consumption.

### CROSS-REFERENCE TO RELATED APPLICATIONS

This application claims priority to U.S. Provisional Application No. 63/411,342 (Attorney Docket CBH 0004MA), filed Sep. 29, 2022, and entitled “SEAWEED FEED PRODUCTS AND METHODS FOR PROCESSING SEAWEED,” and additionally claims priority to U.S. Provisional Application No. 63/486,615 (Attorney Docket: CBH0004MA1), filed Feb. 23, 2023, and entitled “SEAWEED FEED PRODUCTS AND METHODS FOR PROCESSING SEAWEED,” each of which is incorporated by reference it its entirety herein.

### BACKGROUND

### Field

The present specification generally relates to feed products and, more particularly, to animal feed products suitable for ruminants.

### Technical Background

With up to 1.5 billion domestic cattle worldwide, significant greenhouse gas (“GHG”) contribution globally is from cattle, sheep, and other ruminant production systems that are responsible for up to 20% of total global GHG emissions, primarily through emission of methane. Such methane emission is a biproduct of fermentation of feed organic matter in the rumen of the stomach of the unique digestive system of ruminant animals. Accordingly, an urgent need exists for methods and products which can reduce the methane emissions of ruminants.

### SUMMARY

According to one embodiment, a seaweed feed product may comprise halogenated compound-diminished seaweed material, a binding agent, one or more bound halogenated compounds. The one or more bound halogenated compounds may be bound to at least a portion of the binding agent.

According to another embodiment, a ruminant may be fed by a method comprising administering an amount of seaweed feed product to the ruminant effective to reduce methane emission in the ruminant. The seaweed feed product may comprise halogenated compound-diminished seaweed material, a binding agent, one or more bound halogenated compounds. The one or more bound halogenated compounds may be bound to at least a portion of the binding agent.

According to yet another embodiment, a feed product may consist essentially of a binding agent and one or more bound halogenated compounds. The one or more bound halogenated compounds may be bound to at least a portion of the binding agent.

According to yet another embodiment, a ruminant may be fed by a method comprising administering an amount of feed product to the ruminant effective to reduce methane emission in the ruminant. The feed product may consist essentially of a binding agent and one or more bound halogenated compounds. The one or more bound halogenated compounds may be bound to at least a portion of the binding agent.

According to yet another embodiment, seaweed may be processed by a method comprising contacting a harvested seaweed with an aqueous solution comprising a binding agent. The harvested seaweed may comprise one or more halogenated compounds. A portion of the one or more halogenated compounds of the harvested seaweed may be expelled from the harvested seaweed to from a halogenated compound-diminished seaweed material. At least a portion of the one or more expelled halogenated compound may bond with the binding agent to from a bound halogenated compound material. The method may further comprise separating one or both of the bound halogenated compound material and halogenated compound-diminished seaweed material from the aqueous solution.

According to yet another embodiment, a seaweed feed product may comprise halogenated compound-diminished seaweed material comprising red seaweed, a binding agent comprising one or more cyclodextrins, and one or more bound halogenated compounds. The one or more bound halogenated compounds may be bound to at least a portion of the binding agent. The one or more halogenated compounds may comprise bromoform.

According to yet another embodiment, a ruminant may be fed by a method comprising administering an amount of seaweed feed product to the ruminant effective to reduce methane emission in the ruminant. The seaweed feed product may comprise halogenated compound-diminished seaweed material comprising red seaweed, a binding agent comprising one or more cyclodextrins, and one or more bound halogenated compounds. The one or more bound halogenated compounds may be bound to at least a portion of the binding agent. The one or more halogenated compounds may comprise bromoform. Additional features and advantages of the seaweed feed products and associated methods described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification.

### DETAILED DESCRIPTION

Reference will now be made in detail to embodiments of the seaweed feed products described herein, as well as method of processing and use. According to one or more embodiments, the seaweed feed products may include halogenated compound-diminished seaweed material, binding agent, and one or more bound halogenated compounds. As is described in detail herein, it has been discovered that seaweed that includes halogenated compounds, such as bromoform, once harvested, is susceptible to loss of a portion of such halogenated compounds throughout various stages of processing, storage, transportation, and/or other handling prior to reaching the end consumer and subsequent consumption by an animal. This loss of halogenated compounds is undesirable since bromoform, and other halogenated compounds in general, have been identified as a substance that can reduce methane emissions by ruminants. In one or more embodiments described herein, these halogenated compounds that were present in the pre-harvested seaweed are bound to at least a portion of the binding agent present in the seaweed feed product. As such, the halogenated compounds may be preserved in the seaweed feed product rather than being lost to the environment.

As described herein, some embodiments are directed to seaweed feed products. A seaweed feed product, as described herein, refers to any material that is eaten (e.g., consumed and/or digested) by an animal, such as a ruminant, that includes seaweed or processed materials that originated as seaweed. The seaweed feed products described herein, according to various embodiments, may be individually consumed by animals (i.e., the feed is consumed majorly without other feed materials), or may be consumed with other feeds (i.e., the feed is consumed in a mixture with other feed materials or “side-by-side” with other feeds). In some embodiments, the seaweed feed products described herein may constitute a relatively small amount of an animal's overall diet, and may be considered a supplement to another bulk feed. For example, the feeds described herein may be eaten by an animal along with other feeds such as, e.g., forage (including, for example, grass or legume (e.g., alfalfa) forage), silage, corn, soybeans, other seeds, oils, dietary supplements, etc. For example, in some embodiments, the seaweed feed products described herein may be mixed with other feeds such as, e.g., corn and/or soy. In other examples, the animal may graze, or otherwise be provided any of a variety of forage, and be separately fed some amount of the seaweed feed products described herein. It is contemplated that the seaweed feeds described herein may be a portion of a feeding regimen, which may vary by ruminant breed and type, such as dairy cows, beef feed-lot cattle, “high end” cattle (e.g., Wagyu or other higher end cattle types), free range cattle, etc., or may vary by feeding approaches (e.g., feed-lot or grazing systems or a combination of these). Each type of ruminant may have a specialized diet that includes the seaweed feed products along with other additives.

According to various embodiments, the seaweed feed products described herein may be consumed and/or digested by ruminants. As described herein and understood by those skilled in the art, “ruminants” may refer to herbivorous, hoofed mammals (suborder Ruminantia and Tylopoda) that have a complex 3-or 4-chambered stomach. Ruminants include, without limitation, cattle, sheep, deer, goats, giraffes, camels, and llamas. The ruminants described herein may be domesticated, such as ruminants used for direct human food consumption, dairy purposes, and/or recreation. In some embodiments, the ruminants may be dairy cows, beef lot cattle, “high end” cattle such as Wagyu, free range cattle, or others, or may vary by feeding approaches (e.g., feed-lot or grazing systems or a combination of these).

Generally, in embodiments described herein, the seaweed feed products include seaweed material with reduced levels of halogenated compounds (which are naturally present in the seaweed and stored in specialized gland cells), referred to sometimes herein as halogenated compound-diminished seaweed material. Without being bound by any particular theory, it is believed that this reduction in the level of halogenated compounds relative to freshly harvested seaweed may be due to release of these halogenated compounds, which are sometimes classified as volatile organic compounds (“VOCs”), from the seaweed gland cells to the environment during processing, transportation, and/or storage, and the seaweed is therefore halogenated compound-diminished.

As described herein, in some embodiments, some or all of the halogenated compounds that are expelled from the harvested seaweed are VOCs, meaning herein that they have a vapor pressure of greater than 10 Pa at 20 °C or more. VOCs may have a greater propensity to escape from the seaweed gland cells, particularly following harvesting when glands may be ruptured or otherwise damaged or degraded. Some or all of the halogenated compounds disclosed herein may have such a volatility and be considered VOCs when meeting this standard. In one or more embodiments, when describing bound halogenated compounds, the vapor pressure of the bound halogenated compound corresponds to that of the bound halogenated compound in an unbound state (i.e., the vapor pressure of just the halogenated compound.)

In accordance with embodiments presently disclosed, at least a portion of the halogenated compound that is lost from the halogenated compound-diminished seaweed material is present in a “bound halogenated compound material,” which includes one or more “bound halogenated compounds” bound to a “binding agent,” such as one or more cyclic oligosaccharides. The use of binding agent during any of various stages of seaweed processing allows for retention of at least a portion of halogenated compound that would otherwise be lost to the environment.

As described herein, “halogenated compound” refers to any chemical compound that includes a halogen (i.e., fluorine, chlorine, bromine, iodine). As described herein, these halogenated compounds are generally present in the glands of some seaweeds. Throughout this disclosure, the description of a “halogenated compound” or “halogenated compounds” may refer to the one or more halogenated compounds that are present in the seaweed, such as specialized seaweed glands, prior to harvest. In some embodiments, the halogenated compounds are organic, generally meaning that the halogen is bonded to a carbon molecular backbone, as would be understood by those skilled in the art. “Bound halogenated compounds,” as described herein, are those that are bound with the binding agent.

A non-exhaustive listing of contemplated organic halogenated compounds includes bromoform; dibromo(iodo)methane; bromo(diiodo)methane; iodoform, dibromo(chloro)methane; bromo-chloro-iodomethane; dibromomethane; bromo(iodo)methane; diiodomethane; tetrabromomethane; acetyl iodide; 2-iodoethanol; 1-bromo-2-iodoethane; 2,2-dibromoacetaldehyde; 1-bromopropan-2-one; 1-iodopropan-2-one; 1,1-dibromopropan-2-one; 1-bromobutan-2-one; 1-bromo-3-iodopropan-2-one; 1,1,1-tribromopropan-2-one; 1,1-dibromo-1-chloropropan-2-one; 1,3-dibromobutan-2-one; 1,1-dibromo-3-iodopropan-2-one; 1,1,3,3-tetrabromopropan-2-one; 1,1,1,3,3,3-hexachloropropan-2-one; 1,1,3-tribromopropan-2-ol; 1,1,3,3-tetrabromoprop-1-ene; 1,1,3-tribromo-3-chloroprop-1-ene; 1,1-dibromo-3,3-dichloroprop-1-ene; 1,3,3-tribromo-1-iodoprop-1-ene; 3,3-dibromoprop-2-enal; 4,4-dibromobut-3-en-2-one; 1,4,4-tribromobut-3-en-2-one; 1-iodo-4,4-dibromobut-3-en-2-one; 1,1,4,4-tetrabromobut-3-en-2-one; 1,4,4-tribromo-1-chlorobut-3-en-2-one; 1,1,4-tribromo-4-chlorobut-3-en-2-one; 1,1-dibromo-4,4-dichlorobut-3-en-2-one; 1,4-dibromo-1,4-dichlorobut-3-en-2-one; 2-chloroacetic acid; 2-broroacetic acid; 2-iodoacetic acid; 2,2-dichloroacetic acid; 2-bromo-2-chloroacetic acid; 2-iodo-2-chloroacetic acid; 2,2-dibromoacetic acid; 2-iodo-2-broroacetic acid; 2,2-diiodoacetic acid; 3-chloroprop-2-enoic acid; 2-chloroprop-2-enoic acid; 3-bromoprop-2-enoic acid; 3-iodoprop-2-enoic acid; 3-iodoprop-2-enoic acid; 3,3-dichloroprop-2-enoic acid; 2,3-dichloroprop-2-enoic acid; 3,3-dibromoprop-2-enoic acid; 2,3-dibromoprop-2-enoic acid; 3-iodo-3-dibromoprop-2-enoic acid; 2-iodo-3-bromoprop-2-enoic acid; 2-bromo-3-iodoprop-2-enoic acid; 3,3-diiiodoprop-2-enoic acid; 2,3-diiodoprop-2-enoic acid; 2,3,3-tribromoprop-2-enoic acid; 2,3-dibromo,3-iodoprop-2-enoic acid; 2-iodo-3,3-dibromoprop-2-enoic acid; bibromochloromethane, and bromochloromethane. At least bromoform, bibromochloromethane, and bromochloromethane and known to be major constituents of some seaweed varietals such as Asparagopsis taxiformis and Asparagopsis armata

In one embodiment, the halogenated compound includes bromine. Without limitation, of particular interest in the present embodiments is bromoform, which has been demonstrated to reduce methane emissions in ruminants when provided in sufficient dosing. However, without being bound by any theory, it is believed that other halogenated compounds, besides bromoform, may also affect methane emission reduction in ruminants, and so the capture of these other compounds may be also beneficial. In additional embodiments, the halogenated compounds may include iodine, which as described herein may have an effect of palatability of the animal feed. Such iodine compounds, such as iodine salts, may have an adverse effect on palatability and, in some embodiments, these compounds may not be bound with the binding agent and may desirably escape to the environment.

As described herein, the seaweed feed products may comprise halogenated compound-diminished seaweed material and bound halogenated compound material. According to one or more embodiments, the halogenated compound-diminished seaweed material consists of materials derived from and present in unharvested seaweed. Generally, the seaweed materials described herein are materials that result from some processing of harvested seaweed. Harvesting, as used herein, may refer generally to gathering the seaweed crop, such as by cutting or other mechanical means, and removing the seaweed from its growing habitat. In one or more embodiments, the halogenated compound-diminished seaweed materials described herein comprises harvested seaweed that is similar or identical to unharvested seaweed aside from losses of various chemical compounds such as, without limitation, halogenated compounds.

The seaweed material present in the seaweed feed products described herein are “halogenated compound-diminished,” meaning that seaweed materials present in the seaweed feed products include less halogenated compounds than were present in the precursor unharvested seaweed. It should be understood that halogenated compound-diminished seaweed may still include some halogenated compounds. For example, halogenated compounds such as bromoform may be present in the halogenated compound-diminished seaweed material, meaning that not all of the halogenated compound originally present in the unharvested seaweed has escaped the specialized gland cells or other structures of the seaweed in which they were present at harvesting.

In one or more embodiments, the halogenated compound-diminished seaweed material in the seaweed feed products may also be physically altered as compared to the precursor unharvested seaweed, such as mechanically cut, chopped, pulverized, ground, etc. In some embodiments, the halogenated compound-diminished seaweed material may be freeze-dried, where some amount of water may be substantially removed from the halogenated compound-diminished seaweed material as compared with the precursor unharvested seaweed.

In one or more embodiments, the halogenated compound-diminished seaweed material in the seaweed feed products may also be processed to reduce the content of water soluble salts, especially halide salts which may otherwise adversely impact the suitability the halogenated compound-diminished seaweed as a constituent in a seaweed feed product material. For example, reduction of these materials may lead to improved palatability for a ruminant. In some embodiments, the seaweed feed material may have improved palatability to a cow, a sheep, or other ruminants, as compared to freshly harvested seaweed.

As described herein, the halogenated compound-diminished seaweed material may contain materials present in unharvested seaweed, or be otherwise minimally processed as compared with freshly harvested seaweed. As described herein, “seaweed” may refer to any aqueous plant, particularly multicellular marine algae. Seaweed varieties contemplated herein may include, without limitation, Rhodophyta (red), Phaeophyta (brown) and Chlorophyta (green) macroalgae. Such algaes may be grown in or otherwise harvested from fresh or salt water, either in naturally occurring marine environments or in artificial environments such as water tanks, ponds, and the like.

In particular, some seaweeds known to include halogenated compounds, and in particular bromoform, include red seaweeds. Such seaweed varieties include, without limitation, those of the Asparagopsis genus, such as Asparagopsis taxiformis or Asparagopsis Armata. However, it is contemplated that other varieties of seaweed may be discovered that include halogenated compounds, or seaweed genetic variants may be developed with include halogenated compounds, all of which are contemplated as applicable in the presently disclosed embodiments.

The precursor seaweeds that are utilized in the halogenated compound-diminished seaweed materials described herein include some amount of halogenated compound when unharvested. For example, the unharvested seaweeds from which the halogenated compound-diminished seaweed material is derived may include from 0.1 mg to 6 mg of halogenated compound per gram of unharvested seaweed, such as from 0.1 mg to 6 mg of bromoform per gram of unharvested seaweed. Such a measurement can be made immediately after harvest. As described, some of the halogenated compounds present in the unharvested seaweed may be lost from the seaweed once harvested and processed, as well as in storage and transport, sometimes due to the volatilization of halogenated compound, which is undesirable in some embodiments since halogenated compounds can reduce methane generation in ruminants.

As described herein, the seaweed feed product may include a binding agent and one or more bound halogenated compounds that are bound to some or all of the binding agent. The material that includes the halogenated compound bound with the binding agent is sometimes referred to herein as the bound halogenated compound material, where the one or more halogenated compounds are bound to a binding agent.

In one or more embodiments, the binding agent may be any material (including mixtures of chemical compounds) that is capable of binding with the desired halogenated compound or compounds. As described herein, halogenated compound that is “bound” with the binding agent refers to halogenated compound that is chemically bonded to the binding agent. Various chemical bonds are contemplated, such as chemical association (e.g., a complex formed by two or more compounds), hydrogen bonding, covalent bonding, ionic bonding, van der Waals bonding, or polar covalent bonding. Generally, the bonding of these materials, such as cyclic oligosaccharides, will be understood by those skilled in the art. For example, a cyclodextrin may from a complex, or be otherwise associated with, the one or more halogenated compounds contemplated herein. In one non-limiting embodiment, one or more cyclodextrins are bound with bromoform, forming a solid precipitate, by forming a chemical complex or association.

As described herein, the binding agent included in the seaweed feed products described herein may be bound or unbound with one or more halogenated compounds. For example, a portion of the binding agent may be bound with the halogenated compound or compounds and a portion may not be bound with the halogenated compound or compounds. For example, excess binding agent may be present as compared with the stoichiometric bound equivalent of halogenated compound so that all halogenated compound is bound.

According to one or more embodiments, the seaweed feed product may comprise at least 0.01 wt. % of the binding agent (including bound and non-bound binding agent). In additional embodiments, the seaweed feed product may comprise at least 0.02 wt. %, at least 0.03 wt. %, at least 0.04 wt. %, at least 0.05 wt. %, at least 0.1 wt. %, at least 0.2 wt. %, at least 0.3 wt. %, at least 0.4 wt. %, at least 0.5 wt. %, at least 0.6 wt. %, at least 0.7 wt. %, at least 0.8 wt. %, at least 0.9 wt. %, or even at least 1 wt. % of the binding agent. As described herein, the amount of binding agent does not include the halogenated compound that may be bound with the binding agent. By way of example, a mixture of about 1 wt. % cyclodextrin (1 g per 100 g seaweed) may bind about 200 mg bromoform, or about 0.2% in unharvested seaweed.

According to various embodiments, the binding agent may be a naturally occurring or synthetic material or combination of materials with limited or no pharmaceutical activity. For example, the binding agent may comprise materials recognized by those skilled in the art to be harmless to animals when consumed and may be naturally occurring or synthetic materials. In some embodiments, the seaweed feed products described herein do not include any active pharmaceutical ingredients or bioactive materials aside from those that may be present in unharvested seaweed. For example, and without limitation, some cyclic oligosaccharides, such as cyclodextrins, are considered to be substantially or wholly harmless to ruminants and other animals when consumed.

According to one or more embodiments, the binding agents may be organic binding agents or inorganic binding agents, as are discussed herein. Organic binding agents generally include a carbon backbone structure, whereas inorganic binding agents do not, as would be understood by those skilled in the art.

In some embodiments, the organic binding agent may comprise one or more cyclic oligosaccharides. As used herein, the term “cyclic oligosaccharide” means a cyclic structure comprising six or more saccharide units. Some exemplary embodiments for use herein are cyclic oligosaccharides having six, seven, or eight saccharide units and mixtures thereof. It is common in the art to abbreviate six, seven, and eight membered cyclic oligosaccharides to α, β, and γ, respectively.

The cyclic oligosaccharide of the compositions used for the present embodiments may comprise any suitable saccharide or mixtures of saccharides. Examples of suitable saccharides include, but are not limited to, glucose, fructose, mannose, galactose, maltose, and mixtures thereof. In one or more embodiments, the cyclic oligosaccharides for use herein are cyclodextrins, such as alpha-cyclodextrins, beta-cyclodextrins, gamma-cyclodextrins, or mixtures thereof. As described herein, alpha-cyclodextrins include cyclodextrins having 6 glucose subunits (substituted or unsubstituted), beta-cyclodextrins include cyclodextrins having 7 glucose subunits (substituted or unsubstituted), and gamma-cyclodextrins include cyclodextrins having 8 glucose subunits (substituted or unsubstituted).

In one or more embodiments, the cyclic oligosaccharides for use herein are all alpha-cyclodextrins, all beta-cyclodextrins, or all gamma-cyclodextrins. According to additional embodiments, the cyclodextrins included in the compositions described herein may be a mixture of any two or three of alpha-cyclodextrins, beta-cyclodextrins, or gamma-cyclodextrins. For example, the cyclodextrins may comprise or consists of a mixture of alpha-cyclodextrins and beta-cyclodextrins, a mixture of alpha-cyclodextrins and gamma-cyclodextrins, a mixture of beta-cyclodextrins and gamma-cyclodextrins, or a mixture of alpha-cyclodextrin, beta-cyclodextrin, and gamma-cyclodextrins. Without being bound by any particular theory, it is believed that the use of multiple types of cyclodextrins (alpha, beta, or gamma) in combination may allow for the binding of multiple chemical compounds present in seaweed. For example, one type of cyclodextrin may bind to a large degree with bromoform, while another type of cyclodextrin may bind with another chemical compound from the seaweed. Such diversity of binding agents can allow for capture of multiple constituents, which may, in some embodiments, lead to ultimately reduced methane output when consumed by a ruminant.

In some embodiments, the cyclodextrins may include from 0 -10 mol. %, from 10-20 mol. %, from 20-30 mol. %, from 30-40 mol. %, from 40-50 mol. %, from 50-60 mol. %, from 60-70 mol. %, from 70-80 mol. %, from 80-90 mol. %, from 90-100 mol. %, or any combination of these ranges, of alpha-cyclodextrin. In some embodiments, the cyclodextrins may include from 0 -10 mol. %, from 10-20 mol. %, from 20-30 mol. %, from 30-40 mol. %, from 40-50 mol. %, from 50-60 mol. %, from 60-70 mol. %, from 70-80 mol. %, from 80-90 mol. %, from 90-100 mol. %, or any combination of these ranges, of beta-cyclodextrin. In some embodiments, the cyclodextrins may include from 0 -10 mol. %, from 10-20 mol. %, from 20-30 mol. %, from 30-40 mol. %, from 40-50 mol. %, from 50-60 mol. %, from 60-70 mol. %, from 70-80 mol. %, from 80-90 mol. %, from 90-100 mol. %, or any combination of these ranges, of gamma-cyclodextrin.

The cyclic oligosaccharides, or mixture of cyclic oligosaccharides, utilized in the embodiments described herein may be substituted by any suitable substituent or mixture of substituents. Herein the use of the term “mixture of substituents” means that two or more different suitable substituents can be substituted onto a cyclic oligosaccharide. The derivatives of cyclodextrins may consist mainly of molecules wherein some of the hydroxyl groups have been substituted. Suitable substituents include, but are not limited to, alkyl groups; hydroxyalkyl groups; dihydroxyalkyl groups; (hydroxyalkyl)alkylenyl bridging groups such as cyclodextrin glycerol ethers; aryl groups; maltosyl groups; allyl groups; benzyl groups; alkanoyl groups; cationic cyclodextrins such as those containing 2-hydroxy-3-(dimethylamino) propyl ether; quaternary ammonium groups; anionic cyclodextrins such as carboxyalkyl groups, sulphobutylether groups, sulphate groups, and succinylates; amphoteric cyclodextrins; and mixtures thereof.

The substituents may be saturated or unsaturated, straight or branched chain. Some substituents include saturated and straight chain alkyl groups, hydroxyalkyl groups, and mixtures thereof. Some alkyl and hydroxyalkyl substituents are selected from C1-C8 alkyl or hydroxyalkyl groups or mixtures thereof. In some embodiments, alkyl and hydroxyalkyl substituents are selected from C1-C6 alkyl or hydroxyalkyl groups, or mixtures thereof. In additional embodiments, alkyl and hydroxyalkyl substituents are selected from C1-C4 alkyl or hydroxyalkyl groups and mixtures thereof. Embodiments of alkyl and hydroxyalkyl substituents include propyl, ethyl and methyl.

In one or more embodiments, cyclic oligosaccharides for use in the presently disclosed embodiments are unsubstituted, or are substituted by only saturated straight chain alkyl, or hydroxyalkyl substituents. Therefore, some examples of cyclic oligosaccharides for use herein are alpha-cyclodextrin, beta-cyclodextrin, methyl-alpha-cyclodextrin, methyl-beta-cyclodextrin, hydroxypropyl-alpha-cyclodextrin and hydroxypropyl-beta-cyclodextrin. One or more of these compounds are available from Wacker-Chemie GmbH Hanns-Seidel-Platz 4, Munchen, DE under the tradename Alpha W6 M and Beta W7 M respectively.

According to additional embodiments, the organic binding agent may comprise one or more amphiphilic components that combine to form aggregate structures in aqueous systems, said aggregate structures possessing a lipophilic interior in some embodiments. Non-limiting examples of amphiphilic components include ethoxylated castor oil and ethoxylated hydrogenated castor oil. In additional embodiments, the organic binding agent may comprise one or more amphiphilic multi-arm star-block copolymers such as those described by Ternat, et al. (Macromol. Chem. Phys. 208:131 2007). In yet additional embodiments, the organic binding agent may also comprise one or more polymeric emulsifiers possessing a lipophilic portion and a hydrophilic portion. Non-limiting examples of such polymeric emulsifiers include Acrylates/C10-30 Alkyl Acrylate Crosspolymers available under the tradename Pemulen™ by Lubrizol Advanced Materials, Inc. (Cleveland, Ohio, USA).

In additional embodiments, the binding agents may be inorganic binding agents such as, without limitation, molecular sieves such as zeolites. Zeolites may be crystalline aluminosilicates formed by corner sharing [SiO₄]⁴⁻ or [AlO₄]⁵⁻ tetrahedra, which possess periodic one-to-three-dimensional frameworks, unique pore structure, and fine physical and chemical stabilities.

Now described are processes for processing seaweed, which may be utilized for producing the seaweed feed products described herein. Generally, in the processes described herein, harvested seaweed is contacted by a solution that includes the binding agent, and at least a portion of the halogenated compound that escapes from the seaweed is bound by the binding agent. Thus, in one or more embodiments, these halogenated compounds can be retained in the seaweed feed product in the form of the bound halogenated compound material.

According to one or more embodiments, in an initial step, a harvested seaweed may be supplied. In some embodiments, the harvested seaweed may be supplied by harvesting a precursor seaweed. As described herein, the precursor seaweed is the seaweed that forms, following any of a variety of processing steps (e.g., cutting, packaging, etc.), the seaweed material of the seaweed feed products described herein. As discussed herein, harvesting, may refer generally to gathering the seaweed crop, such as by cutting or other mechanical means, and removing the seaweed from its growing habitat. In other embodiments, the harvested seaweed may be supplied by another party, and the following steps are equally applicable.

The loss of halogenated compounds from the harvested seaweed is generally undesirable, according to some embodiments described herein, since it may be advantageous to retain halogenated compound in the seaweed if being fed to ruminants to reduce methane emission. It has been discovered presently that the amount of halogenated compounds that are expelled from the seaweed between harvesting and animal consumption can be significant, and may begin very shortly following harvesting. Thus, it is desirable to capture and retain this lost halogenated compound as opposed to losing it to the environment.

Following the supplying of the harvested seaweed, the harvested seaweed may be contacted with an aqueous solution comprising the binding agent. In general, the harvested seaweed may be submerged in the aqueous solution, such as in a holding tank. In such embodiments, the contents of the holding tank may be stirred or otherwise agitated. Once harvested, a portion of the one or more halogenated compounds of the harvested seaweed may be expelled from the harvested seaweed. This expelling of the one or more halogenated compounds may be by volatilization of the halogenated compounds, which allows the halogenated compound to escape the harvested seaweed. This loss of halogenated compound, which can occur naturally, forms the halogenated compound-diminished seaweed materials described herein.

According to embodiment disclosed herein, at least a portion of the expelled halogenated compound bonds with the binding agent, forming the bound halogenated compound material (including both binding agent and halogenated compound). In some embodiments, the expelled halogenated compound and the binding agent are dissolved in the aqueous solution, and precipitate out of solution once the bonding occurs. Thus, in these embodiments, the expelled halogenated compound may be retained as a solid composition comprising, at least in part, the aforesaid bound halogenated compound material. This solid composition may be suitable for consumption by animals, and allows for relatively easy transport and compatibility of the bound halogenated compound material in solid seaweed feed products. For example, the association of a cyclodextrins with bromoform can form a solid material.

As described previously herein, the halogenated compound may begin to volatilize and be expelled from the harvested seaweed relatively quickly following harvesting. In such embodiments, it may be beneficial to quickly contact the harvested seaweed with the aqueous solution comprising the binding agent. For example, according to one or more embodiments, the contacting of the harvested seaweed with the aqueous solution may initially occur within 1 hour of the harvesting of the seaweed. In additional embodiments, the contacting of the harvested seaweed with the aqueous solution may initially occur within 30 minutes, within 15 minutes, within 5 minutes, within 1 minute, within 45 seconds, within 30 seconds, or even within 15 seconds of the harvesting of the seaweed.

According to embodiments, the contacting time of the harvested seaweed with the aqueous solution may include a wide time range, and is not necessarily limited. Generally, the harvested seaweed can be contacted with the aqueous solution when the seaweed is ready for subsequent processing or/or packaging steps, discussed later here. In additional embodiments, the contacting time may be for a time sufficient for a desired amount of halogenated compound to be expelled into the aqueous solution and be bound with the binding agent. This time period may depend on the initial amount of halogenated compound present in the harvested seaweed, intervening processing steps that could reduce halogenated compound content in the harvested seaweed prior to contacting, and the rate at which the halogenated compound is expelled from the seaweed while in contact with the aqueous solution.

Based on the above timing considerations, in one or more embodiments, the contacting of the harvested seaweed with the aqueous solution may be for a time period of from 5 minutes to 1 month, such as from 5 minutes to 1 hour, from 1 hour to 6 hours, from 6 hours to 12 hours, from 12 hours to 24 hours, from 24 hours to 2 days, from 2 days to 1 week, from 1 week to 2 weeks, from 2 weeks to 1 month, or any combination of these ranges.

As described herein, it is contemplated that additional processing steps may occur between harvesting and/or supplying of a harvested seaweed and initial contact with the aqueous solution. For example, in some embodiments, the harvested seaweed may be transported by boat from its harvesting site prior to contact with the aqueous solution. In additional embodiments, the harvested seaweed may be physically altered, such as by cutting, chopping, or the like, prior to contact with the aqueous solution.

In additional embodiments, the harvested seaweed may be physically altered, such as by cutting, chopping, or the like, while in contact with the aqueous solution. Without being bound by theory, it is believed that such some mechanical processing may increase the rate of expulsion of the halogenated compounds from the harvested seaweed into the aqueous solution. For example, it is believed that the rupturing of glands that hold the halogenated compounds in the seaweed can release halogenated compounds, such as bromoform, into the environment. In such embodiments, halogenated compound expulsion can be intentionally increased, forming additional bound halogenated compound material. This may be advantageous since less halogenated compound remains in the seaweed material following removal from contact with the aqueous solution, such that less halogenated compound has the opportunity to escape into the environment in downstream processing and prior to consumption by the animal.

As is described herein, the aqueous solution that contacts the harvested seaweed includes a binding agent, which may include one or more compounds capable of forming a bond with halogenated compound. The concentration of binding agent in the aqueous solution may vary based on several factors, such as the ratio of aqueous solution to harvested seaweed during contacting and the amount of expected halogenated compound that will be expelled from the harvested seaweed during contacting with the aqueous solution. The amount of expected halogenated compound that will be expelled from the harvested seaweed during contacting with the aqueous solution may depend on at least the time of contact, the amount of halogenated compound present in the harvested seaweed upon contacting, and the rate at which the halogenated compound is expelled from the seaweed while in contact with the aqueous solution. As an example, the amount of binding agent initially in the aqueous solution (at initial contacting with the seaweed) may be determined such that the binding agent is similar in molar amount as to the expelled halogenated compound (assuming a 1:1 molar bonding ratio between halogenated compound and the binding agent). That is, in one or more embodiments, the binding agent may be the non-limiting reagent, such that there is no appreciable excess halogenated compound that is not captured. However, the amount of binding agent initially in the aqueous solution may be limited as to not waste excess binding agent based on cost considerations.

In embodiments, if precipitation occurs during the bonding process, the organic binding material is dissolved in the aqueous solution prior to bonding with the halogenated compound. Cyclic oligosaccharides may be particularly suitable due to their relatively high solubility. The cyclic oligosaccharides of the compositions used for the present embodiments may be soluble in water. As used herein “soluble” means at least about 0.1 g of solute dissolves in 100 mL of solvent, at 25 °C and 1 standard atmospheric pressure (760 mmHg). In some embodiments, the cyclic oligosaccharides for use herein have a solubility of at least about 1 g/ 100 mL, at 25 °C and 1 atm of pressure. In some embodiments, the cyclic oligosaccharides are only present at levels up to their solubility limits in a given composition at room temperature.

It is contemplated that the contacting of the harvested seaweed with the aqueous solution containing the binding agent may be a batch or continuous process, as would be understood by those in the art.

The methods described herein may allow for significant amounts of halogenated compounds that were present in the harvested seaweed to be present as halogenated compounds in the bound halogenated compound material. For example, the seaweed feed product may comprise at least 0.01 wt. % of the bound halogenated compound material, based on the total weight of the seaweed feed product. In additional embodiments, the seaweed feed product may comprise at least 0.02 wt. %, at least 0.03 wt. %, at least 0.04 wt. %, at least 0.05 wt. %, at least 0.1 wt. %, at least 0.2 wt. %, at least 0.3 wt. %, at least 0.4 wt. %, at least 0.5 wt. %, at least 0.6 wt. %, at least 0.7 wt. %, at least 0.8 wt. %, at least 0.9 wt. %, or even at least 1 wt. % of the bound halogenated compound material based on the total weight of the seaweed feed product.

In additional embodiments, the seaweed feed product may comprise at least 1 wt. % of the bound halogenated compound material based on the total weight of the seaweed feed product, or even at least 2 wt. %, at least 3 wt. %, at least 4 wt. %, at least 5 wt. %, at least 10 wt. %, at least 15 wt. %, at least 20 wt. %, at least 25 wt. %, or even at least 50 wt. %. For example, such embodiments may utilize a separation step following processing whereby a portion or all of the halogenated compound-diminished seaweed material is separated from the bound halogenated compound material. Such a seaweed feed product could be administered to a ruminant in relatively concentrated doses of bromoform or other halogenated compounds along with other feed materials.

According to some embodiments, the bound halogenated compound material may be completely or nearly completely separated from the seaweed materials. In such embodiments, the feed product may consist or consist essentially of (i.e., 99 wt. % or greater) of binding agent and halogenated compounds, where little or no seaweed material is present.

Following the contacting of the harvested seaweed with the aqueous solution containing the binding agent, separation of one or both of the halogenated compound-diminished seaweed material and the bound halogenated compound material from the aqueous solution may take place. This may be by simple liquid/solid separation, as in some embodiments that bound halogenated compound material is a precipitate solid. Such separation may be performed by sieves or the like, and/or by processes such as centrifugation and the like. This separation has the potential to remove water soluble salts dissolved from the seaweed into the aqueous solution, especially halide salts which may otherwise adversely impact the suitability the halogen compound-diminished seaweed as a constituent in a seaweed feed product material. As would be understood by those skilled in the art, “separating” these materials may include non-complete separation, where some limited amount of the aqueous solution remains present on the halogenated compound-diminished seaweed material and the bound halogenated compound material following separation.

Following separation, the halogenated compound-diminished seaweed material and the bound halogenated compound material may remain separated, combined, or be re-combined if applicable, which may constitute a seaweed feed product as described herein. However, in additional embodiments, additional processing steps may take place on the halogenated compound-diminished seaweed material, the bound halogenated compound material, or the combination of these materials in a mixture. For example, the halogenated compound-diminished seaweed material, the bound halogenated compound material, or the combination of these materials in a mixture may be freeze dried, or otherwise dried to remove residual water, transported, thawed, aged, washed, packaged, etc., prior to consumption by an animal in a seaweed feed product.

According to additional embodiments described herein, the seaweed feed product may comprise an oil, such as a plant oil, which may reduce additional halogenated compound losses. For example, the seaweed feed product may be susceptible to additional halogenated compound loss (from the halogenated compound-diminished seaweed material) when it is exposed to the environment. In one embodiment, an oil is sprayed, misted, or the like, over at least a portion of the outside of the seaweed feed product. Such use of oil may reduce halogenated compound losses to the environment as, without being bound by theory, the oil may bond or otherwise restrict movement of the halogenated compound that is continually released by the halogenated compound-deficient seaweed material. Contemplated oils include, without limitation, coconut oil, corn oil, cottonseed oil, olive oil, palm oil, peanut oil, rapeseed oil, safflower oil, sesame oil, soybean oil, sunflower oil, canola oil, or other vegetable oils, including any mixtures of any of the foregoing.

According to additional embodiments, the seaweed feed product may further comprise molasses or other viscous sugar material. Incorporation of molasses may significantly reduce dust and odor may be masked, increasing palatability. Without being bound by theory, it is believed that the incorporation of molasses may “encapsulate” the seaweed, which may mitigate odor, improve palatability, retain bromoform or other halogenated compounds. Molases may be used in combination with oil. In one embodiment, 100 grams of seaweed material (dried weight) may be mixed with 10 mL of canola oil and 10 grams of molasses. Canola may be sprayed initially onto the seaweed material and then be mixed. Then, molasses may be added, which may be heated to modify the viscosity.

According to the processes described herein, in various embodiments, a majority the seaweed feed products produced may comprise the combination of the halogenated compound-diminished seaweed material and the binding agent. For example, the seaweed feed product may comprise at least 50 wt. %, at least 75 wt. %, at least 85 wt. %, at least 95 wt. %, at least 99 wt. %, at least 99.5 wt. %, or even at least 99.9 wt. % of the combination of the halogenated compound-diminished seaweed material and binding agent.

According to one or more embodiments described herein, the seaweed feed product may additionally comprise other materials in addition to the halogenated compound-diminished seaweed material and bound halogenated compound material. For example, the seaweed feed products described herein may further comprise grains that are whole, ground, or steamed including barley, sorghum, oats, wheat, corn and other similar grains fed to cattle; grasses/silage materials that are whole, ground or pelleted including lucerne, corn silage, straw, hay; cellulosic waste streams that are whole or ground including cotton seed, almond hulls, spent grains, citrus peels; or combinations of these. In additional embodiments, the seaweed feed products described herein may further comprise flow control agents such as silica, tri calcium phosphate, etc. to avoid clumpiness, allow for material flow in bulk situations. In additional embodiments, the seaweed feed products described herein may further comprise other stability enhancers such as antioxidants (e.g., Vit E) etc. to avoid any oxidation stability concerns. In additional embodiments, the seaweed feed products described herein may further comprise added vitamins, minerals, and other nutrients. In further embodiments, the seaweed feed products described herein may incorporate active pharmaceutical ingredients.

In additional embodiments, the seaweed feed product may comprise other bound chemical compounds (formed from non-halogenated compound) that form bonds with the binding agent. For example, non-halogenated chemical compounds may also be expelled from the harvested seaweed while in contact with the aqueous solution and be bound with the binding agent. If these bound materials are precipitated out of solution, they may be present with the halogenated compound-diminished seaweed material and bound halogenated compound material in the seaweed feed product. However, in some embodiments, based on the selection of the binding agent, amounts of these materials that form in the contacting step may be relatively small, such as in a molar ratio with bound halogenated compound material of less than 1:1.

However, in one or more embodiments, binding agents may be utilized that have some selectivity for what materials are bound and/or precipitated. For example, the halogenated compound-diminished seaweed material, and the seaweed feed product as a whole, may include less iodine-containing compounds, such as iodide salts, than are present in the precursor unharvested seaweed. This aspect may be beneficial since iodine-containing compounds, such as iodide salts, included in seaweed feed products may have a poor taste, which may cause rejection as a food source by the ruminant. As such, in some embodiments, iodine-containing compounds, such as iodine salts, are present is lesser amounts in the seaweed feed products described herein than in harvested seaweed, particularly if the binding agent either does not form a bond with or does not form a precipitate with the particular iodine-containing compound. It is believed this may be the case for at least the cyclodextrins disclosed herein.

According to one or more embodiments, the amount of iodine salts present in the seaweed feed material may be less than or equal to 1000 mg per g of dry seaweed. In additional embodiments, the amount of iodine salts present in the seaweed feed material may be less than or equal to 600 mg per g of dry seaweed, which may reduce feed rejection by the ruminant. In additional embodiments, the amount of iodine salts present in the seaweed feed material may be less than or equal to 340 mg per g of dry seaweed, which may further increase palatability of the feed.

Additionally, without being bound by theory, it is believed that bromoform may be more susceptible to volatilization and, thus, be expelled from the harvested seaweed more than other bromine-containing compounds. In some embodiments, this means that relatively little non-bromoform-containing compounds are lost from the harvested seaweed (i.e., these compounds are present in a good degree in the halogenated compound-diminished seaweed material). This aspect may be beneficial in the seaweed feed products since it is believed, without being bound by any particular theory, that non-bromoform compounds may also contribute to methane emission reduction in ruminants.

In general, in the embodiments disclosed herein, the halogenated compounds present in the bound halogenated compound material and in the halogenated compound-diminished seaweed material is the same material originally present in the harvested seaweed. Generally speaking, in some embodiments, the main difference in the seaweed feed product from the harvested seaweed, in terms of chemicals present, is the addition of the binding agent, while retaining the majority of the halogenated-containing compounds originally present in the unharvested seaweed such as bromoform as well as others. Such embodiments may be superior to alternatives such as synthetic halogenated compound or isolated halogenated compound, which may be carcinogenic and are known to contribute to ozone depletion.

According to additional embodiments, the present disclosure is directed to methods for feeding ruminants. According to such methods, an amount of seaweed feed product that is effective to reduce methane emission in the ruminant may be administered to the ruminant. As described herein, administering the seaweed feed product may include a variety of steps, such as providing the ruminant with the seaweed feed product and allowing the ruminant to eat and digest the seaweed feed product. For example, the seaweed feed product could be mixed with other feeds or could be supplied individually to the ruminant. Administration of the seaweed feed products disclosed herein to animals can be, according to various embodiments, on a continuous basis (e.g., eaten daily with normal food rations) or at particular spaced apart times (e.g., about once a week or once a month).

Described now herein is the digestive system of a ruminant, according to various embodiments contemplated herein, where throughout this description no particular theory is relied upon. The digestive system of ruminant animals differs from non-ruminant animals in that the total stomach consists of four compartments: (1) rumen, (2) reticulum, (3) omasum, and (4) abomasum. This unique configuration permits combination of microbial fermentation of feedstuffs by a large microbial population in combination with typical mammalian digestive processes to permit utilization of feed components such as cellulose which cannot be digested by the latter digestive processes in non-ruminant animals.

Ruminants may swallow much of their feedstuffs without chewing it sufficiently. This partially chewed material is termed “cud” and the bidirectional functionality of the esophagus permits regurgitation of the cud into the mouth for additional chewing and mixing with saliva for further particulate size reduction. This material is then swallowed again and passed into the reticulum where the filtration process discussed previously permits liquid and smaller particles of appropriate density to transit into the omasum and subsequently into the abomasum. The retained larger particulates and those with densities outside the ideal range of 1.1 and 1.3g/cm³ , and small amounts of associated fluid may slowly move into the rumen for fermentation. Ruminal retention times for 2 mm fiber particles of 42 to 56 hr have been reported, a fourfold increase over the retention time of fluid, with larger particles exhibiting progressively large retention times up to 52-67 hr for 8 mm particles. The total process is termed rumination, and both increases the surface area and exposes new surfaces of the fibrous matrix through repeated mastication for bacterial action. The iterative mastication activity typically continues until most of the ruminal contents are less than 1 mm and can transit through the reticulum into the omasum.

The solid portion left behind in the rumen from a roughage diet may typically remain for up to 48 hours and forms a dense mat in the rumen. Rumen microorganisms (primarily bacteria) digest cellulose from plant cell walls, digest complex starch, synthesize protein from nonprotein nitrogen, and synthesize B vitamins and vitamin K. Ruminal fermentation may initially result in the degradation of carbohydrates and protein to short-term intermediates such as sugars and amino acids. The products of this initial degradation may be further metabolized to microbial mass, the gases carbon dioxide, methane, hydrogen sulfide, ammonia, and volatile fatty acids (VFA): primarily acetate, propionate, and butyrate and to a lesser degree branched chain VFA and occasionally lactate. Key biproducts of carbohydrate fermentation to VFA may be hydrogen and carbon dioxide.

The rumen luminal environment may be anaerobic with fluid pH values typically ranging from 6.5 to 6.8. However, measured volumes vary with reported values of about 50-55 L, 40-60 L, and 85-102 L. Reported fluid emptying rates may vary with temperature and range from 1.8 to 3.2 L/hr at 26 and 41 °C with retention times of 18.7 to 13.5 hr, respectively.

As described previously herein, biproducts of carbohydrate fermentation are hydrogen and carbon dioxide. If hydrogen is not removed it can inhibit further metabolism by rumen microorganisms. Removal of hydrogen may be provided by a group of Archaea, known collectively as methanogens, which belong to the phylum Euryarcheota. This group is phylogenetically distinct from both eukaryotes and bacteria, although many live in close association with anaerobic bacteria such as are present in the anaerobic environment of the rumen.

Hydrogen removal may be accomplished through the process of methanogenesis. Methanogenesis in microbes is a form of anaerobic respiration. Methanogens do not use oxygen to respire; in fact, oxygen may inhibit the growth of methanogens. The terminal electron acceptor in methanogenesis is not oxygen, but carbon. The carbon can occur in a small number of organic compounds, all with low molecular weights. Two described pathways involve the use of acetic acid or inorganic carbon dioxide as terminal electron acceptors. The pathways may be complex, but are summarized in the simple equations:

CO₂+4H₂→CH₄+2H₂O

CH₃COOH→CH₄+CO₂

Since most of the acetate (CH₃COOH) produced in the rumen is systemically absorbed through the rumen walls, carbon dioxide may be the primary carbon compound used in ruminal methanogenesis.

The principal methanogens in the bovine rumen utilize hydrogen and carbon dioxide, but there may be niche groups that utilize other substrates. Nonetheless, removal of hydrogen from the ruminal environment as a terminal step of carbohydrate fermentation by methanogens permits the microorganisms involved in fermentation to function optimally and support the complete oxidation of substrates.

Methane production in cattle may be a function of diet, but may peak about 5-6 hr post-feeding with a biphasic decline in rate thereafter. The initial rapid decline in production rate may last until about 12-15 hr post-feeding with a more gradual rate of decline over the remaining 9-12 hr until the next feeding.

Without being bound by any particular theory, according to one or more embodiments, the administration of halogenated compound may reduce the amount of methane produced by ruminants via the inhibition of ruminal methanogenesis. For example, one or more chemical pathways described herein which ultimately produce methane may be inhibited by exposure to halogenated compound.

According to embodiments described herein, the halogenated compound may be administered to the ruminant in the form of the described seaweed feed products. That is, the halogenated compound may be included in the bound halogenated compound material, which also includes a binding agent such as one or more cyclodextrins. Once administered to the ruminant, the halogenated compound may disassociate from the binding agent, and the binding agent may be digested or otherwise expelled by the ruminant. Without being bound by any particular theory, it is believed that the administration of the halogenated compound to the ruminant while bound to the binding agent may act to modify the release of the halogenated compound to the ruminant. For example, as the halogenated compound is decoupled from the binding agent, the halogenated compound may be continuously released into the ruminant, rather than having all of the halogenated compound consumed by the ruminant be instantly exposed directly to the ruminant to inhibit methane formation.

In additional embodiments, bound halogenated compound material (the halogenated compound bonded with the binding agent) may be administered to the ruminant through use of a bolus or a lick. In such embodiments utilizing boluses or licks, the bound halogenated compound material may be completely or nearly completely separated from the seaweed materials, and then incorporated into a bolus or lick that is subsequently administered to a ruminant. In such embodiments, the bolus or lick may comprise, consist, or consist essentially of (i.e., 99 wt. % or greater) of binding agent and halogenated compounds, along with other conventional materials used in a bolus or lick, such as bonding agents and other conventional materials supplied to ruminants via lick or bolus, where little or no seaweed-derived material is present aside from the halogenated compound. In some embodiments, other additives may be present in the bolus or lick, such as conventionally known substances that are present in known boluses and licks, as described herein. In additional embodiments, some additional seaweed-derived material may be present in the bolus or lick aside from the bound halogenated compound.

As described herein, a bolus refers to a type of oral supplement that is commonly used for ruminants, such as cattle, sheep, and goats. The bolus may be a relatively large, capsule-like tablet that is designed to release its contents slowly over a period of time. Boluses can be used for various purposes, such as to deliver minerals, vitamins, or medications to the animal, or to treat specific conditions such as parasite infestations. Typical ruminant boluses may be made up of an outer layer of a hard, slow-dissolving material that surrounds a core of the active ingredients. The bolus may be designed to remain in the animal's rumen (the first compartment of its four-chambered stomach) for several weeks or months, slowly releasing the contents as the outer layer dissolves. The slow release of the bolus may ensure that the animal receives a relatively consistent dose of the active ingredients (such as bromoform) over a prolonged period of time.

As describe herein, a lick refers to a mixture of materials such as salts, minerals, and sometimes other ingredients (such as bromoform) that are made into a concentrated block or spread on a flat surface. These licks are made available to ruminants, such as cattle, sheep, and goats, as a way to supplement their diet with essential minerals that may not be present in their normal feed. For example, a common lick for ruminants can be made with a mixture of salt, minerals such as magnesium, calcium, and phosphorus, and sometimes molasses or other ingredients to make it more palatable. Licks contemplated herein may further include halogenated compounds such as bound bromoform). The lick may then formed into a block or spread on a flat surface, such as a metal or plastic plate, and made available to the animals.

Without being bound by theory, it is believed that the incorporation of cyclodextrin into a bolus may contribute to controlled release of the halogenated material. Additionally, it is believed that the incorporation of cyclodextrin into a lick may contribute to improved stability of halogenated materials, such as bromoform.

Without limitation, contemplated embodiments of boluses include those that may have a lifetime of about 30 day sand deliver about 300 mg of bromoform per day. Such a bolus may utilize about 9 grams of bromoform, where the total weight of the bolus may be about 100 grams.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

The present disclosure includes numerous aspects, referred to as Aspects 1-70, as described hereinbelow.

Aspect 1. A seaweed feed product comprising: halogenated compound-diminished seaweed material; a binding agent; and one or more bound halogenated compounds, wherein the one or more bound halogenated compounds are bound to at least a portion of the binding agent.

Aspect 2. The seaweed feed product of aspect 1, wherein the seaweed feed product comprises at least 0.01 wt. % of the binding agent.

Aspect 3. The seaweed feed product of any preceding aspect, wherein the bound halogenated compounds bound with the bind agent form a bound halogenated compound material that is solid.

Aspect 4. The seaweed feed product of any of aspects 1-3, wherein the binding agent comprises one or more cyclic oligosaccharides.

Aspect 5. The seaweed feed product of any of aspects 1-3, wherein the binding agent comprises one or more cyclodextrins.

Aspect 6. The seaweed feed product of any of aspects 1-3, wherein binding agent comprises an alpha-cyclodextrin, a beta-cyclodextrin, a gamma-cyclodextrin, or mixtures thereof.

Aspect 7. The seaweed feed product of any of aspects 1-3, wherein the binding agent comprises an alpha-cyclodextrin.

Aspect 8. The seaweed feed product of any of aspects 1-3, wherein the binding agent comprises a beta-cyclodextrin.

Aspect 9.The seaweed feed product of any of aspects 1-3, wherein the binding agent comprises one or more zeolites.

Aspect 10.The seaweed feed product of any preceding aspect, wherein the one or more bound halogenated compounds comprise bromoform.

Aspect 11. The seaweed feed product of any preceding aspect, wherein one or more of the bound halogenated compounds have a vapor pressure of greater than 10 Pa or greater at 20 °C or greater when in an unbound state.

Aspect 12. The seaweed feed product of any preceding aspect, wherein the halogenated compound-diminished seaweed material comprises one or more halogenated compounds.

Aspect 13. The seaweed feed product of any preceding aspect, wherein the seaweed material comprises red seaweed.

Aspect 14. The seaweed feed product of any preceding aspect, wherein the seaweed-based material comprises Asparagopsis taxiformis, Asparagopsis armata, or combinations of these.

Aspect 15. The seaweed feed product of any preceding aspect, wherein one or both of: the seaweed feed product comprises at least 50 wt. % of the combination of the halogenated compound-diminished seaweed material and binding agent; and the iodine salts present in the seaweed feed product is less than or equal to 1000 mg per gram of halogenated compound-diminished seaweed material.

Aspect 16. A method for feeding a ruminant, the method comprising: administering an amount of seaweed feed product to the ruminant effective to reduce methane emission in the ruminant, wherein the seaweed feed product is the seaweed feed product of any preceding aspect.

Aspect 17. The method of aspect 16, wherein the ruminant is a cow.

Aspect 18. The method of aspect 16, wherein the ruminant is a sheep.

Aspect 19. The method of aspect 16, wherein the seaweed feed material has improved palatability to a cow, a sheep, or both, as compared to freshly harvested seaweed.

Aspect 20. The method of aspect 16, wherein the ruminant is beef lot, “high end” ruminant, a dairy cow, or a free range cattle.

Aspect 21. The method of aspect any of aspects 16-20, wherein the ruminant is also administered forage, grain, or combinations thereof.

Aspect 22. A feed product consisting essentially of: a binding agent; and one or more bound halogenated compounds, wherein the one or more bound halogenated compounds are bound to at least a portion of the binding agent.

Aspect 23. The feed product of aspect 22, wherein the bound halogenated compound material is solid.

Aspect 24. The feed product of aspect 22 or 23, wherein the binding agent comprises one or more cyclic oligosaccharides.

Aspect 25. The feed product of aspect 22 or 23, wherein the binding agent comprises one or more cyclodextrins.

Aspect 26. The feed product of aspect 22 or 23, wherein binding agent comprises alpha-cyclodextrin, beta-cyclodextrin, gamma-cyclodextrin, or mixtures thereof.

Aspect 27. The feed product of aspect 22 or 23, wherein the binding agent comprises an alpha-cyclodextrin.

Aspect 28. The feed product of aspect 22 or 23, wherein the binding agent comprises a beta-cyclodextrin.

Aspect 29. The feed product of aspect 22 or 23, wherein the binding agent comprises one or more zeolites.

Aspect 30. The feed product of any of aspects 22-29, wherein the one or more bound halogenated compounds comprise bromoform.

Aspect 31. The feed product of any of aspects 22-30, wherein one or more of the bound halogenated compounds have a vapor pressure of greater than 10 Pa or greater at 20 °C or greater when in an unbound state.

Aspect 32. A method for feeding a ruminant, the method comprising: administering an amount of feed product to the ruminant effective to reduce methane emission in the ruminant, wherein the feed product is the feed product of any of aspects 22-31.

Aspect 33. The method of aspect 32, wherein the ruminant is a cow.

Aspect 34. The method of aspect 32, wherein the ruminant is a sheep.

Aspect 35. The method of aspect 32, wherein the seaweed feed material has improved palatability to a cow, a sheep, or both, as compared to freshly harvested seaweed.

Aspect 36. The method of aspect 32, wherein the ruminant is beef lot, “high end” ruminant, a dairy cow, or a free range cattle.

Aspect 37. The method of aspect 32, wherein the ruminant is also administered forage, grain, or combinations thereof.

Aspect 38. A method for processing seaweed, the method comprising: contacting a harvested seaweed with an aqueous solution comprising a binding agent, wherein: the harvested seaweed comprises one or more halogenated compounds; a portion of the one or more halogenated compounds of the harvested seaweed is expelled from the harvested seaweed to from a halogenated compound-diminished seaweed material; and at least a portion of the one or more expelled halogenated compound bonds with the binding agent to from a bound halogenated compound material; separating one or both of the bound halogenated compound material and halogenated compound-diminished seaweed material from the aqueous solution.

Aspect 39. The method of aspect 38, wherein the bound halogenated compound material precipitates out of the aqueous solution.

Aspect 40. The method of aspect 38 or 39, wherein the contacting comprises submerging the harvested seaweed in the aqueous solution.

Aspect 41. The method of any of aspects 38-40, wherein the contacting of the harvested seaweed with the aqueous solution may initially occur within 1 hour of the harvesting of the seaweed.

Aspect 42. The method of any of aspects 38-41, wherein the contacting of the harvested seaweed with the aqueous solution is for a time period of from 5 minutes to 1 month.

Aspect 43. The method of any of aspects 38-42, further comprising harvesting a precursor seaweed to form a harvested seaweed, wherein the precursor seaweed comprises one or more halogenated compounds.

Aspect 44. The method of any of aspects 38-43, wherein the binding agent comprises one or more cyclodextrins.

Aspect 45. The method of any of aspects 38-44, further comprising physically altering the halogenated compound-diminished seaweed material.

Aspect 46. A seaweed feed product comprising: halogenated compound-diminished seaweed material comprising red seaweed; a binding agent comprising one or more cyclodextrins; and one or more bound halogenated compounds, wherein the one or more bound halogenated compounds are bound to at least a portion of the binding agent, and wherein the one or more halogenated compounds comprise bromoform.

Aspect 47. The seaweed feed product of aspect 46, wherein the one or more cyclodextrins comprise an alpha-cyclodextrin, a beta-cyclodextrin, a gamma-cyclodextrin, or mixtures thereof.

Aspect 48. The seaweed feed product of aspect 46 or 47, wherein the halogenated compound-diminished seaweed material comprises one or more halogenated compounds.

Aspect 49. The seaweed feed product of any of aspects 46-48 wherein the halogenated compound-diminished seaweed material comprises Asparagopsis taxiformis, Asparagopsis armata, or combinations of these.

Aspect 50. A method for feeding a ruminant, the method comprising: administering an amount of seaweed feed product to the ruminant effective to reduce methane emission in the ruminant, wherein the seaweed feed product is the seaweed feed product of any of aspects 46-49.

Aspect 51. The method of aspect 50, wherein the ruminant is a cow.

Aspect 52. The method of aspect 50, wherein the ruminant is a sheep.

Aspect 53. The method of aspect 50, wherein the seaweed feed material has improved palatability to a cow, a sheep, or both, as compared to freshly harvested seaweed.

Aspect 54. The method aspect 50, wherein the binding agent comprises a gamma-cyclodextrin.

Aspect 55. The method aspect 50, wherein the binding agent comprises any two of an alpha-cyclodextrin, a beta-cyclodextrin, and a gamma-cyclodextrin.

Aspect 56. The method of aspect 50, wherein the binding agent comprises alpha-cyclodextrin, a beta-cyclodextrin, and a gamma-cyclodextrin.

Aspect 57. The feed product of aspect 22 or 23, wherein the binding agent comprises a gamma-cyclodextrin.

Aspect 58. The feed product of aspect 22 or 23, wherein the binding agent comprises any two of an alpha-cyclodextrin, a beta-cyclodextrin, and a gamma-cyclodextrin.

Aspect 59. The feed product of aspect 22 or 23, wherein the binding agent comprises alpha-cyclodextrin, a beta-cyclodextrin, and a gamma-cyclodextrin.

Aspect 60. The seaweed feed product of aspect 46, wherein the one or more cyclodextrins comprise an alpha-cyclodextrin.

Aspect 61. The seaweed feed product of aspect 46, wherein the one or more cyclodextrins comprise a beta-cyclodextrin.

Aspect 62. The seaweed feed product of aspect 46, wherein the one or more cyclodextrins comprise a gamma-cyclodextrin.

Aspect 63. The seaweed feed product of aspect 46, wherein the one or more cyclodextrins comprise any two of an alpha-cyclodextrin, a gamma-cyclodextrin, and a gamma-cyclodextrin.

Aspect 64. The seaweed feed product of aspect 46, wherein the one or more cyclodextrins comprise an alpha-cyclodextrin, a gamma-cyclodextrin, and a gamma-cyclodextrin.

Aspect 65. A bolus comprising: a binding agent; and one or more bound halogenated compounds, wherein the one or more bound halogenated compounds are bound to at least a portion of the binding agent.

Aspect 66. The bolus of aspect 65, wherein the binding agent comprises one or more cyclodextrins, and wherein the one or more bound halogenated compounds comprise bromoform.

Aspect 67. A bolus comprising the feed product of any of aspect 22-31.

Aspect 68. A method for administering a halogenated compound to a ruminant, the method comprising inserting the bolus of aspect 67 into the rumen of the ruminant.

Aspect 69. A lick comprising the feed product of any of aspects 22-31.

Aspect 70. A method for administering a halogenated compound to a ruminant, the method comprising supplying the lick of aspect 69 to the rumen.

1. A seaweed feed product comprising:
halogenated compound-diminished seaweed material;
a binding agent; and
one or more bound halogenated compounds, wherein the one or more bound halogenated compounds are bound to at least a portion of the binding agent.

2. The seaweed feed product of claim 1, wherein the seaweed feed product comprises at least 0.01 wt. % of the binding agent.

3. The seaweed feed product of claim 1, wherein the bound halogenated compounds bound with the bind agent form a bound halogenated compound material that is solid.

4. The seaweed feed product of any of claim 1, wherein the binding agent comprises one or more cyclic oligosaccharides.

5. A method for feeding a ruminant, the method comprising:
administering an amount of seaweed feed product to the ruminant effective to reduce methane emission in the ruminant, wherein the seaweed feed product is the seaweed feed product of claim 1.

6. A feed product consisting essentially of:
a binding agent; and
one or more bound halogenated compounds, wherein the one or more bound halogenated compounds are bound to at least a portion of the binding agent.

7. A bolus comprising the feed product of claim 6.

8. A method for administering a halogenated compound to a ruminant, the method comprising inserting the bolus of claim 7 into the rumen of the ruminant.

9. A lick comprising the feed product of claim 6.

10. A method for administering a halogenated compound to a ruminant, the method comprising supplying the lick of claim 9 to the rumen.

11. A method for processing seaweed, the method comprising:
contacting a harvested seaweed with an aqueous solution comprising a binding agent, wherein:
the harvested seaweed comprises one or more halogenated compounds;
a portion of the one or more halogenated compounds of the harvested seaweed is expelled from the harvested seaweed to from a halogenated compound-diminished seaweed material; and
at least a portion of the one or more expelled halogenated compound bonds with the binding agent to from a bound halogenated compound material;
separating one or both of the bound halogenated compound material and halogenated compound-diminished seaweed material from the aqueous solution.

12. The method of claim 11, wherein the bound halogenated compound material precipitates out of the aqueous solution.

13. The seaweed feed product of claim 1, wherein:
the halogenated compound-diminished seaweed material comprises red seaweed;
the binding agent comprises one or more cyclodextrins; and
the one or more halogenated compounds comprise bromoform.

14. The seaweed feed product of claim 13, wherein the one or more cyclodextrins comprise an alpha-cyclodextrin, a beta-cyclodextrin, a gamma-cyclodextrin, or mixtures thereof.

15. A bolus comprising:
a binding agent; and
one or more bound halogenated compounds, wherein the one or more bound halogenated compounds are bound to at least a portion of the binding agent.

16. The seaweed feed product of claim 4, wherein the one or more cyclic oligosaccharides comprise one or more cyclodextrins.

17. The seaweed feed product of claim 16, wherein the one or more cyclodextrins comprise an alpha-cyclodextrin, a beta-cyclodextrin, a gamma-cyclodextrin, or mixtures thereof.

18. The feed product of claim 6, wherein the binding agent comprises one or more cyclic oligosaccharides.

19. The method of claim 11, wherein the binding agent comprises one or more cyclic oligosaccharides.

20. The bolus of claim 15, wherein the binding agent comprises one or more cyclic oligosaccharides.
